(19) United States
(12) Patent Application Publication
(10) Pub. No.: US 2024/0362678 A1
(43) Pub. Date: Oct. 31, 2024

(54) GENERATING SIGNALS FOR MACHINE LEARNING, DISPLAYING CONTENT, OR DETERMINING USER PREFERENCES BASED ON VIDEO DATA CAPTURED WITHIN A RETAILER LOCATION

(71) Applicant: Maplebear Inc. (dba Instacart), San Francisco, CA (US)

(72) Inventors: Chakshu Ahuja, San Jose, CA (US); Girija Narlikar, Palo Alto, CA (US); Karuna Ahuja, San Francisco, CA (US)

(21) Appl. No.: 18/141,396

(22) Filed: Apr. 29, 2023

(51) Int. Cl. G06Q 30/0251; G06N 20/00

(52) U.S. Cl. CPC G06Q 30/0261; G06N 20/00

(57) ABSTRACT

For each retailer location associated with multiple retailers, an online system associated with the retailers receives video data captured within the retailer location by a camera of a client device associated with an online system user. The online system detects, based at least in part on the video data, a location associated with the user within the retailer location and/or an interaction by the user with an item included among an inventory of the retailer location. The online system generates a set of signals associated with the user based at least in part on the detection of the location and/or the interaction. Based at least in part on the set of signals, the online system determines a set of preferences associated with the user, trains a machine learning model to predict a metric associated with the user, and/or sends content for display to a client device associated with the user.

### BACKGROUND

Online systems, such as online concierge systems, provide customers with the convenience of placing orders that are subsequently fulfilled on their behalf and delivered to them. Online systems often collect information associated with their customers from customer client devices associated with the customers and use this information to improve the experience of the customers (e.g., by making recommendations to the customers, by sending content to the customers, etc.). For example, based on information describing previous orders placed by a customer with an online system and received from a customer client device associated with the customer, the online system may send coupons to the customer client device for items the customer previously ordered. As an additional example, suppose that an online system is associated with a grocery retailer and that the online system has collected information indicating that a customer has a preference for spicy foods and barbeque based on browsing and interactions with spicy foods and barbeque-related items received from a customer client device associated with the customer. In this example, the online system may send a recommendation to the customer client device for a spicy barbeque sauce that was recently added to an inventory of the grocery retailer.

Although information describing the actions of customers within retailer locations is likely to yield useful information that also may be leveraged by online systems to improve the experience of their customers, this information may be technologically difficult for the online systems to collect. For example, if a customer picks up an item from a shelf at a retailer location and later puts it back on the shelf because the customer decided it was too expensive, it may be difficult for the online system to collect information describing this interaction without relying on the customer or an employee at the retailer location to report it. In this example, since the online system may be unable to determine that the customer is even interested in the item without this information, the online system may miss out on an opportunity to provide an incentive for the customer to later purchase the item (e.g., by sending a coupon or a discount for the item to a customer client device associated with the customer). As such, by failing to collect information about their customers actions within retailer locations, online systems may forgo opportunities to improve the experience of their customers, which may have a negative impact on customer retention.

### SUMMARY

In accordance with one or more aspects of the disclosure, an online system generates signals for machine learning, displaying content, or determining user preferences based on video data captured within a retailer location. More specifically, for each retailer location associated with multiple retailers, an online system associated with the retailers receives video data captured within the retailer location by a camera of a client device associated with a user of the online system. The online system detects, based at least in part on the video data, a location associated with the user within the retailer location and/or an interaction by the user with an item included among an inventory of the retailer location. The online system then generates a set of signals associated with the user based at least in part on the detection of the location and/or the interaction. Based at least in part on the set of signals, the online system determines a set of preferences associated with the user, trains a machine learning model to predict a metric associated with the user, and/or sends content for display to a client device associated with the user.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 is a flowchart of a method for generating signals for machine learning, displaying content, or determining user preferences based on video data captured within a retailer location, in accordance with one or more embodiments.

FIG. 4 illustrates an example of detecting a location associated with a user of an online system within a retailer location, in accordance with one or more embodiments.

FIG. 5 illustrates an example of detecting an interaction by a user of an online system with an item included among an inventory of a retailer location, in accordance with one or more embodiments.

### DETAILED DESCRIPTION

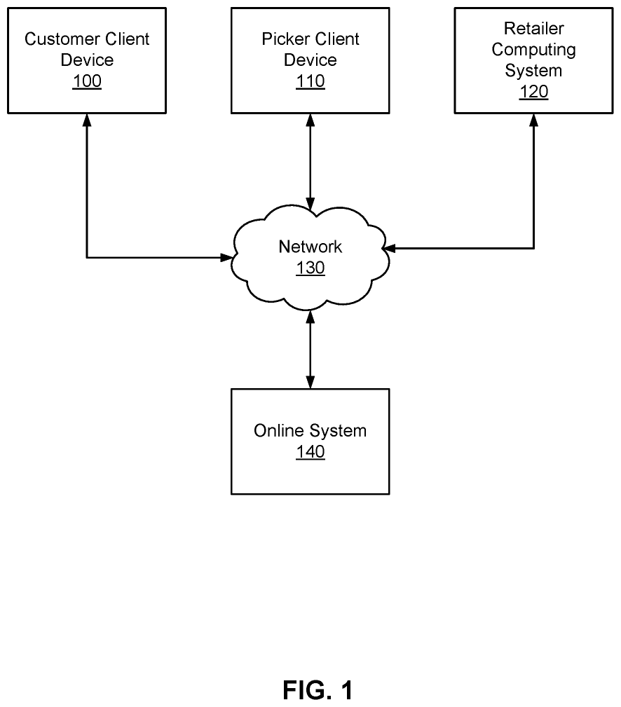

FIG. 1 illustrates an example system environment for an online system 140, such as an online concierge system, in accordance with one or more embodiments. The system environment illustrated in FIG. 1 includes a customer client device 100, a picker client device 110, a retailer computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or a desktop computer. The customer client device 100 also may be an augmented reality device, a mixed reality device, a shopping cart system (e.g., a smart shopping cart), or any other suitable type of device. In some embodiments, the customer client device 100 executes a client application that uses an application programming interface (API) to communicate with the online system 140.

The customer client device 100 may include one or more sensors (e.g., cameras, GPS or proximity sensors, etc.) that are capable of capturing various types of information. For example, if the customer client device 100 is a pair of augmented reality glasses, a camera of the augmented reality glasses may capture image or video data that is visible to a user wearing the augmented reality glasses. As an additional example, if the customer client device 100 is a shopping cart system, one or more cameras mounted on a basket of the shopping cart system facing the interior and/or exterior of the basket may capture image or video data of the interior and/or exterior of the basket. In the above examples, GPS and proximity sensors of the customer client device 100 may be capable of capturing information describing a location of the customer client device 100 (e.g., within a retailer location).

A customer uses the customer client device 100 to place an order with the online system 140. An order specifies a set of items to be delivered to the customer. An “item,” as used herein, refers to a good or product that may be provided to the customer through the online system 140. The order may include item identifiers (e.g., a stock keeping unit or a price look-up code) for items to be delivered to the customer and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the customer has selected for an order but that has not yet been finalized for an order. The ordering interface allows a customer to update the shopping list, e.g., by changing the quantity of items, adding or removing items, or adding instructions for items that specify how the items should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the customer to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer location. The picker client device 110 presents the items that are included in the customer's order to the picker in a collection interface. The collection interface is a user interface that provides information to the picker identifying items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 provides instructions to a picker for delivering the items for a customer's order. For example, the picker client device 110 displays a delivery location from the order to the picker. The picker client device 110 also provides navigation instructions for the picker to travel from the retailer location to the delivery location. If a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140. Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 may provide item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a customer's order (e.g., as a commission). In some embodiments, the retailer computing system 120 may provide data to the online system 140 captured by one or more sensors (e.g., cameras, GPS or proximity sensors, etc.) at a retailer location.

The customer client device 100, the picker client device 110, the retailer computing system 120, and the online system 140 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

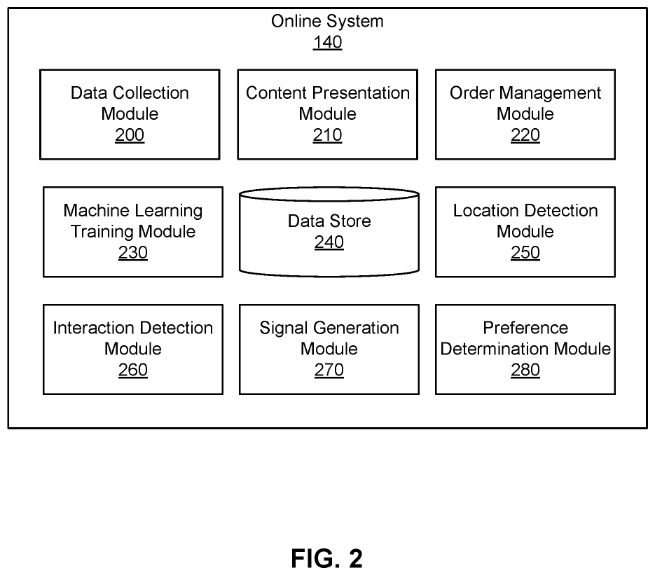

The online system 140 may be an online concierge system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provide portions of the payment from the customer to the picker and the retailer. As an example, the online system 140 may allow a customer to order groceries from a grocery store retailer. The customer's order may specify which groceries they want delivered from the grocery store and the quantities of each of the groceries. The customer client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

FIG. 2 illustrates an example system architecture for an online system 140, such as an online concierge system, in accordance with some embodiments. The system architecture illustrated in FIG. 2 includes a data collection module 200, a content presentation module 210, an order management module 220, a machine learning training module 230, a data store 240, a location detection module 250, an interaction detection module 260, a signal generation module 270, and a preference determination module 280. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may collect data captured by one or more sensors on a customer client device 100, one or more sensors at a retailer location, or any other suitable source. Furthermore, data collected by the data collection module 200 may include or be received in association with information describing one or more times associated with the data. For example, image or video data collected by the data collection module 200 may include a time at which they were captured (e.g., as a timestamp associated with each image or video frame). The data collection module 200 may only collect data describing a user if the user has previously explicitly consented to the online system 140 collecting data describing the user. Additionally, the data collection module 200 may encrypt all data, including sensitive or personal data, describing users.

The data collection module 200 collects customer data, which is information or data that describe characteristics or other types of information associated with a customer. Customer data may include a customer's name, address, shopping preferences, favorite items, favorite retailers, stored payment instruments, dietary preferences (e.g., vegetarian, gluten-free, etc.), or demographic information (e.g., age, gender, etc.). The customer data also may include default settings established by a customer, such as a default retailer/retailer location, payment instrument, delivery location, or delivery timeframe. Customer data also may include historical information, such as historical interaction information or historical order/purchase information associated with a customer. For example, customer data may include information describing previous orders placed by a customer with the online system 140 or information describing previous purchases made by the customer at retailer locations. As an additional example, customer data may include a geographical location of a retailer location at which a customer shopped, a name of a retailer that operates the retailer location, information describing aisles or departments within the retailer location visited by the customer, times at which the customer visited the aisles/departments, etc. As yet another example, customer data may include information describing items (e.g., item types, and prices) with which a customer interacted, information describing the interactions (e.g., picking up the items, putting the items back, adding the items to a shopping cart or a shopping list, searching for the items, clicking on the items, etc.), and times of the interactions. Furthermore, customer data may include information that may be derived from other customer data, such as a frequency with which a customer orders an item, an average number of items included in each order placed by the customer, etc. The data collection module 200 may collect the customer data from sensors on the customer client device 100, the preference determination module 280, or based on a customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the sizes, colors, weights, stock keeping units (SKUs), serial numbers, prices, item categories, brands, sales, discounts, qualities (e.g., freshness, ripeness, etc.), ingredients, materials, manufacturing locations, or any other suitable attributes of the items. The item data may further include purchasing rules associated with each item, if they exist. For example, age-restricted items such as alcohol and tobacco are flagged accordingly in the item data. Item data may also include information that is useful for predicting the availability of items at retailer locations. For example, for each item-retailer combination (a particular item at a particular retailer location), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or a customer client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. In some embodiments, item categories may be broader in that the same item category may include item types that are related to a common theme, found in the same department, etc. For example, items such as soy sauce, ramen, and miso soup may be included in an “Asian foods” item category. Furthermore, in various embodiments, an item may be included in multiple categories. For example, cookies may be included in a “cookies” item category, a “snack foods” item category, as well as a “bakery department” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a customer rating for the picker, the retailers from which the picker has collected items, or the picker's previous shopping history. Additionally, the picker data may include preferences expressed by the picker, such as their preferred retailers for collecting items, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. In this example, the content presentation module 210 then displays the items with scores that exceed some threshold (e.g., the top n items or the p percentile of items).

The content presentation module 210 also may select content for presentation to a customer in the form of a notification (e.g., a push notification), a banner, a recommendation, a content item in a feed of content items, or in any other suitable form. In such embodiments, the content presentation module 210 may select the content based on item data for the items, customer data for the customer, and/or a set of signals associated with the customer generated by the signal generation module 270, as further described below. For example, based on a set of signals indicating that a customer picked up an item at a retailer location, put it in a shopping basket, then put it back on a shelf, and left the retailer location without purchasing it, the content presentation module 210 may select an offer, a coupon, a discount, or an advertisement for the item for presentation to the customer. As an additional example, based on a set of signals indicating that a customer picked up an item at a retailer location and put it back on a shelf, the content presentation module 210 may select content for presentation to the customer that describes how the item may be used (e.g., a recipe that includes the item as an ingredient, a social networking post that demonstrates how the item may be used, etc.). In the above examples, the content presentation module 210 may overlay the content onto the item at the retailer location if the customer client device 100 is an augmented reality device and the customer is at the retailer location. Alternatively, in the above examples, the content may be presented via a client application operating on the customer client device 100 while the customer is at the retailer location or after the customer has left the retailer location.

In some embodiments, the content presentation module 210 may send content for display to a customer client device 100 in association with additional types of information. Examples of such types of information include: instructions for navigating to an item associated with the content, a time limit associated with the content (e.g., to claim an offer included in the content), or any other suitable types of information. For example, the content presentation module 210 may access a layout of a retailer location from the data store 240 and determine a navigation path from a location associated with a customer within the retailer location detected by the location detection module 250 (described below) to an area within the retailer location at which an item associated with content selected for presentation to the customer may be collected. Continuing with this example, the content presentation module 210 may then send the content to the customer client device 100 in association with the navigation path.

The content presentation module 210 may use a machine learning model to score items for presentation to a customer. The machine learning model may be trained to predict a metric associated with a customer, such as a likelihood of conversion for an item by the customer, a maximum amount the customer is likely to spend on a type of item, an affinity of the customer for a brand, a relevance of a content item to the customer, the customer's click-through rate for a content item, or any other suitable type of metric. For example, the content presentation module 210 may use an item selection model, which is a machine learning model that is trained to score items for a customer based on item data for the items and customer data for the customer. In this example, the item selection model may be trained to predict a likelihood that a customer will place an order including an item with the online system 140 or purchase the item from a retailer location. In some embodiments, the machine learning model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding). The content presentation module 210 also may score items for presentation to a customer based on item data for the items, customer data for the customer, and/or a set of signals associated with the customer generated by the signal generation module 270, as further described below. For example, the content presentation module 210 may score items for presentation to a customer based on a relatedness of the items to a search query received from a customer client device 100 associated with the customer and on customer data and signals associated with the customer indicating affinities of the customer for the items. As an additional example, based on a relatedness of items to a search query received from a customer client device 100 associated with a customer and likelihoods that the customer will order the items, the content presentation module 210 may score items for presentation to the customer. In this example, the likelihoods may be predicted by a machine learning model (e.g., the item selection model), which may be trained based on item data for the items, customer data for the customer, and a set of signals associated with the customer generated by the signal generation module 270.

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weigh the score for an item based on the predicted availability of the item. Alternatively, the content presentation module 210 may filter out items from presentation to a customer based on whether the predicted availability of the item exceeds a threshold.

In various embodiments, the content presentation module 210 scores items based on information received from one or more picker client devices 110. The information received from the picker client device(s) 110 may describe an availability of an item, a popularity of an item, or any other suitable types of information. For example, if information received from picker client devices 110 indicates that an item is being collected from a retailer location at a rate that is at least a threshold rate, the content presentation module 210 may weigh the score for the item more heavily than the scores for items that are not being collected from the retailer location at rates that are at least the threshold rate. As an additional example, based on information received from a picker client device 110 indicating that fewer than a threshold number of an item are available at a retailer location, such that the item is discounted for quick clearance, the content presentation module 210 may weigh the score for the item more heavily than the scores for items that are not discounted for quick clearance.

The order management module 220 manages orders for items from customers. The order management module 220 receives orders from customer client devices 100 and assigns the orders to pickers for service based on picker data. For example, the order management module 220 assigns an order to a picker based on the picker's location and the retailer location from which the ordered items are to be collected. The order management module 220 may also assign an order to a picker based on how many items are in the order, a vehicle operated by the picker, the delivery location, the picker's preferences for how far to travel to deliver an order, the picker's ratings by customers, or how often a picker agrees to service an order.

In some embodiments, the order management module 220 determines when to assign an order to a picker based on a delivery timeframe requested by the customer who placed the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit instructions to the picker client device 110 to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online system 140. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model is used by the machine learning model to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

In embodiments in which the content presentation module 210 accesses a machine learning model (e.g., an item selection model) that is trained to predict a metric associated with a customer, the machine learning training module 230 may train the model. The machine learning training module 230 may train the machine learning model via supervised learning based at least in part on attributes of items included among the item data stored in the data store 240 and attributes of customers, which may be included among the customer data stored in the data store 240, and/or a set of signals associated with a customer generated by the signal generation module 270, as described below. In some embodiments, the machine learning model uses item embeddings describing items and customer embeddings describing customers to predict a metric associated with a customer. These item embeddings and customer embeddings may be generated by separate machine learning models and may be stored in the data store 240.

To illustrate an example of how a machine learning model may be trained to predict a metric associated with a customer, suppose that the machine learning training module 230 receives a set of training examples. In this example, the set of training examples may include attributes of items (e.g., sizes, colors, weights, SKUs, serial numbers, prices, item categories, brands, sales, discounts, qualities, ingredients, materials, manufacturing locations, etc. associated with the items). In this example, the set of training examples also may include attributes of customers, such as their shopping preferences, favorite items, favorite retailers, dietary preferences, demographic information, etc. Continuing with this example, the attributes of the customers further may include information describing content presented to the customers (e.g., information included in the content, a type of customer client device 100 used to present the content, a time at which the content was presented, etc.) and information describing the customers' interactions with the content (e.g., clicking on it, claiming an offer included in it, etc.). In the above example, the attributes of the customers also may include information describing the customers' interactions with items in the online system 140 or at retailer locations, such as information describing types of the interactions (e.g., browsing items, picking up items, putting items back, clicking on items, etc.), times of the interactions, and information identifying the items. In this example, the machine learning training module 230 also may receive labels which represent expected outputs of the machine learning model (e.g., whether a customer performed an action associated with an item corresponding to a conversion by ordering/purchasing it). Continuing with this example, the machine learning training module 230 may then train the machine learning model based on the attributes of the items and customers, as well as the labels by comparing its output from input data of each training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In situations in which the training example includes a label, the loss function is also based on the label for the training example. Some example loss functions include the mean square error function, the mean absolute error, the hinge loss function, and the cross-entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

The data store 240 also may store one or more layouts of one or more retailer locations. In some embodiments, a layout of a retailer location may be received from and updated by the retailer computing system 120. A layout of a retailer location may be stored in the data store 240 in association with information that uniquely identifies the retailer location, such as a name of the retailer location, a geographical location of the retailer location, etc. For example, a layout of a retailer location may be stored in association with GPS coordinates associated with the retailer location, a combination of a name of a retailer associated with the retailer location and a city and state in which the retailer location is located, etc.

A layout of a retailer location may describe departments and/or physical elements within the retailer location, such as organizational elements, including aisles, shelves within the aisles, various display areas (e.g., frozen or refrigerated display cases, display tables, and sample and promotional displays), etc., as well as their arrangement within the retailer location. In addition to organizational elements, a layout of a retailer location also may describe additional physical elements within the retailer location, such as items included among an inventory of the retailer location, service counters (e.g., for various departments and/or checkout counters), and various building elements (e.g. entrances/exits, floors, ceilings, walls, stairs, elevators, etc.), and their arrangement within the retailer location. A layout of a retailer location also may include one or more images of departments and physical elements within the retailer location captured from one or more angles, positions, etc.

Additionally, a layout of a retailer location may describe a set of locations within the retailer location associated with each item included among its inventory. A location within a retailer location associated with an item may correspond to a particular area within the retailer location at which the item may be collected. For example, a layout of a retailer location may describe one or more locations within the retailer location associated with an item, in which each location corresponds to a particular aisle, a particular shelf, a particular display table, a particular promotional display, etc., at which the item may be collected.

The location detection module 250 detects a location and/or an orientation associated with a customer within a retailer location. The location detection module 250 may do so based at least in part on data captured by one or more sensors of a customer client device 100 associated with the customer or by one or more sensors at the retailer location. For example, based on data captured by GPS and proximity sensors of a customer client device 100 associated with a customer, the location detection module 250 may detect a location and/or an orientation associated with the customer within a retailer location (e.g., facing a shelf in an aisle or a department within the retailer location). In some embodiments, the location detection module 250 may access a layout of a retailer location (e.g., from the data store 240) and determine one or more types of items associated with a location and/or an orientation associated with a customer within the retailer location based on the layout. In the above example, based on a layout of the retailer location, if the location associated with the customer within the retailer location corresponds to a meat department, the location detection module 250 may determine that the customer is associated with items in the meat department. Furthermore, in this example, if the location associated with the customer within the meat department does not change for at least a threshold amount of time and the location is closest to a freezer with poultry, the location detection module 250 may determine that the orientation associated with the customer is towards items corresponding to frozen poultry.

In embodiments in which data captured by one or more sensors of a customer client device 100 associated with a customer or by one or more sensors at a retailer location are image or video data, the location detection module 250 may detect a location and/or an orientation associated with the customer within the retailer location using one or more computer-vision techniques. To do so, the location detection module 250 may apply the computer-vision technique(s) to the image or video data, access a layout of the retailer location, compare the physical elements included in the image or video data to the layout, and detect the location and/or the orientation associated with the customer within the retailer location based on the comparison. For example, suppose that the data collection module 200 receives image or video data captured by a camera of a customer client device 100 as a customer associated with the customer client device 100 travels along a route through a retailer location, in which the image or video data includes various physical elements (e.g., items, aisles, display tables, faces, hands, shopping baskets, etc.) within the retailer location. In this example, the location detection module 250 may apply image processing, pattern recognition, and object detection techniques to the image or video data to detect and identify the physical elements. Continuing with this example, the location detection module 250 may then access a layout of the retailer location and compare the physical elements included in the image or video data to those of various locations within the layout. In the above example, the location detection module 250 may then detect a location and/or an orientation associated with the customer within the retailer location based on the comparison (e.g., if the physical elements included in the image or video data have at least a threshold measure of similarity to those for a corresponding location/orientation in the layout). In some embodiments, a location and/or an orientation associated with a customer within a retailer location detected by the location detection module 250 may be associated with one or more times. For example, if video data used by the location detection module 250 to detect a location and an orientation associated with a customer within a retailer location includes a timestamp associated with each video frame, the location and orientation associated with the customer may be associated with a timespan during which the video data indicates the customer is associated with the location and orientation.

The interaction detection module 260 detects an interaction by a customer with an item included among an inventory of a retailer location. Similar to the location detection module 250, the interaction detection module 260 may do so based at least in part on data captured by one or more sensors of a customer client device 100 associated with the customer or by one or more sensors at the retailer location. In some embodiments, the sensor(s) may be one or more cameras, such that the data captured by the sensor(s) may be image or video data. In such embodiments, the interaction detection module 260 may detect the interaction by the customer with the item by applying one or more computer-vision techniques to the image or video data. For example, suppose that the data collection module 200 receives image or video data captured by a camera of a customer client device 100, in which the image or video data includes various physical elements (e.g., items, aisles, display tables, faces, hands, shopping baskets, etc.) within a retailer location. In this example, the interaction detection module 260 may apply image processing, pattern recognition, and object detection techniques to the image or video data to detect and identify the physical elements. Continuing with this example, the interaction detection module 260 may then detect that a customer associated with the customer client device 100 picked up an item and subsequently put the item back on a shelf at the retailer location. Alternatively, in the above example, the interaction detection module 260 may detect that the customer placed the item in a shopping basket or a shopping cart after picking it up and subsequently acquired the item by purchasing it from the retailer location. In some embodiments, an interaction by a customer with an item detected by the interaction detection module 260 may be associated with one or more times. For example, if video data used by the interaction detection module 260 to detect an interaction by a customer with an item at a retailer location includes a timestamp associated with each video frame, the interaction may be associated with a timespan during which the interaction is depicted by the video data.

In some embodiments, the signal generation module 270 may generate a set of signals associated with a customer based on a location and/or an orientation associated with the customer within a retailer location detected by the location detection module 250. In such embodiments, the set of signals may include information describing the retailer location, one or more times at which the location and/or the orientation are associated with the customer, one or more types of items associated with the location and/or the orientation associated with the customer, or any other suitable types of information. For example, if the location detection module 250 detects that a customer is located within a frozen food aisle within a retailer location and is oriented towards certain items (e.g., ice cream), the signal generation module 270 may generate a set of signals associated with the customer including information identifying the retailer location and an amount of time that the customer is in the aisle and oriented towards the items.

In various embodiments, the signal generation module 270 also may generate a set of signals associated with a customer based on an interaction by the customer with an item included among an inventory of a retailer location detected by the interaction detection module 260. In such embodiments, the set of signals may include information associated with the item (e.g., brand, item category/categories, price, sale, discount, ingredient(s), size(s), color(s), weight, SKU, serial number, quality, material(s), manufacturing location, etc.). The set of signals also may include information describing the retailer location, a type of the interaction, such as picking up the item, purchasing the item, putting the item back (e.g., on a shelf, a table, or other display area), putting the item in a shopping basket or a shopping cart, one or more times associated with the interaction by the customer with the item, or any other suitable types of information. For example, if the interaction detection module 260 detects that a customer picked up an item, put it back, and left a retailer location without purchasing it, the set of signals may include information identifying the retailer location, information describing the item (e.g., brand, price, item category/categories, etc.), a time at which the customer picked it up, and a time at which the customer put it back.

The preference determination module 280 may determine a set of preferences associated with a customer. Preferences associated with a customer may include shopping preferences, dietary preferences (e.g., vegetarian, gluten-free, etc.), or any other suitable types of preferences. For example, a customer may have a preference for certain brands of items, certain categories of items (e.g., cheeses or Italian food), certain ingredients (e.g., whole grains, gluten-free, etc.), and certain qualities of items (e.g., organic green bananas). The preference determination module 280 may determine a set of preferences associated with a customer based on a set of signals associated with the customer generated by the signal generation module 270. For example, if a set of signals generated by the signal generation module 270 indicates that while at a retailer location, a customer spent ten minutes in a gourmet foods department, the preference determination module 280 may determine that the customer has a preference for gourmet foods from that retailer location. As an additional example, if a set of signals indicates that a customer never spends any time in an alcohol aisle of a first retailer location, but spends several minutes in an alcohol aisle of a second retailer location, the preference determination module 280 may determine that the customer is not interested in alcohol from the first retailer location, but is interested in alcohol from the second retailer location. As yet another example, if a set of signals generated by the signal generation module 270 indicates that after picking up items from a meat department of a retailer location, a customer put the items back if they were not on sale, but purchased the items if they were on sale, the preference determination module 280 may determine that the customer has a preference for items in the meat department at the retailer location that are on sale. Once the preference determination module 280 has determined a set of preferences associated with a customer, the set of preferences may be collected by the data collection module 200 and included among the customer data stored in the data store 240.

Generating Signals for Machine Learning, Displaying Content, or Determining User Preferences Based on Video Data Captured within a Retailer Location

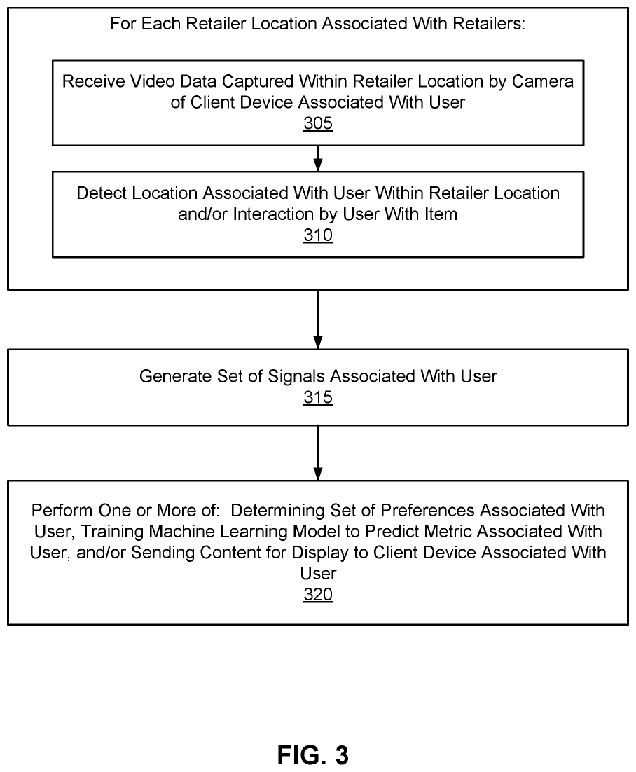

FIG. 3 is a flowchart of a method for generating signals for machine learning, displaying content, or determining user preferences based on video data captured within a retailer location, in accordance with one or more embodiments. Alternative embodiments may include more, fewer, or different steps from those illustrated in FIG. 3, and the steps may be performed in a different order from that illustrated in FIG. 3. These steps may be performed by an online system (e.g., online system 140), such as an online concierge system. Additionally, each of these steps may be performed automatically by the online system 140 without human intervention.

For each retailer location associated with one or more retailers associated with the online system 140, the online system 140 receives 305 (e.g., via the data collection module 200) data captured within the retailer location. The data may be captured by one or more sensors of a customer client device 100 associated with a customer, one or more sensors at the retailer location, or any other suitable source. In embodiments in which the data received 305 by the online system 140 are captured by the customer client device 100, the customer client device 100 may be an augmented reality device, a mixed reality device, a shopping cart system (e.g., a smart shopping cart), or any other suitable type of device. The sensor(s) (e.g., cameras, GPS or proximity sensors, etc.) may be capable of capturing various types of information included in the data. For example, if the customer client device 100 is a pair of augmented reality glasses, a camera of the augmented reality glasses may capture image or video data that is visible to a user wearing the augmented reality glasses. As an additional example, if the customer client device 100 is a shopping cart system, one or more cameras mounted on a basket of the shopping cart system facing the interior and/or exterior of the basket may capture image or video data of the interior and/or exterior of the basket. In the above examples, GPS and proximity sensors of the customer client device 100 may be capable of capturing information describing a location of the customer client device 100 (e.g., within the retailer location). The data may include or be received 305 in association with information describing one or more times associated with the data. For example, if the data are image or video data, the data may include a time at which they were captured (e.g., as a timestamp associated with each image or video frame).

For each retailer location associated with the retailer(s) associated with the online system 140, the online system 140 also may detect 310 (e.g., using the location detection module 250) a location and/or an orientation associated with the customer within the retailer location. The online system 140 may detect 310 the location and/or the orientation associated with the customer within the retailer location based at least in part on the data received 305 by the online system 140. For example, based on data captured by GPS and proximity sensors of the customer client device 100 received 305 by the online system 140, the online system 140 may detect 310 a location and/or an orientation associated with the customer within the retailer location (e.g., facing a shelf in an aisle or a department within the retailer location). In some embodiments, the online system 140 may access a layout of the retailer location (e.g., from the data store 240) and determine one or more types of items associated with the location and/or the orientation associated with the customer within the retailer location based on the layout. In the above example, based on a layout of the retailer location, if the location associated with the customer within the retailer location corresponds to a meat department, the online system 140 may determine that the customer is associated with items in the meat department. Furthermore, in this example, if the location associated with the customer within the meat department does not change for at least a threshold amount of time and the location is closest to a freezer with poultry, the online system 140 may determine that the orientation associated with the customer is towards items corresponding to frozen poultry.

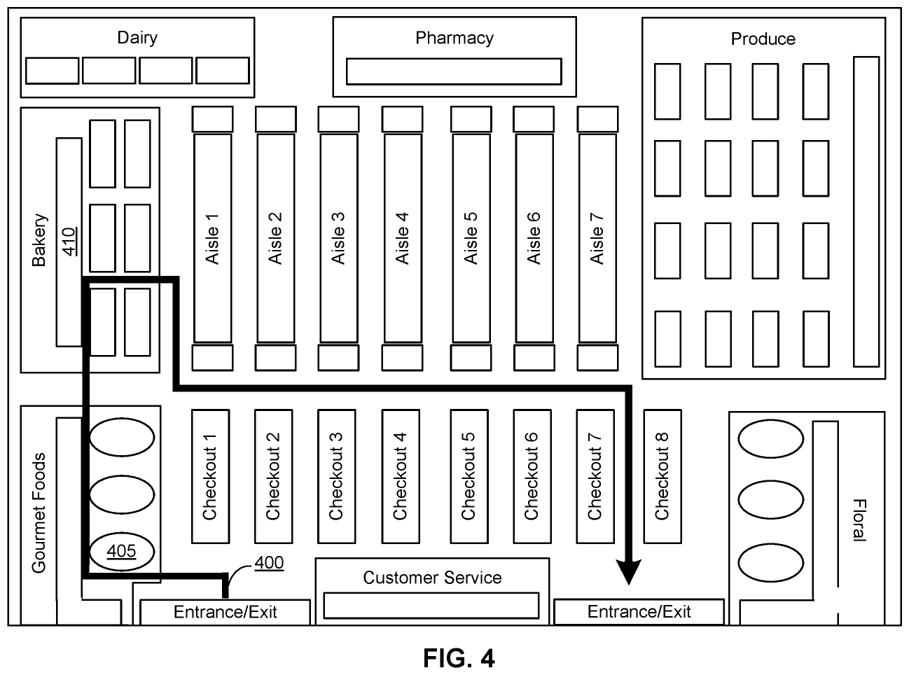

In embodiments in which the data captured by the sensor(s) are image or video data, the online system 140 may detect 310 the location and/or the orientation associated with the customer within the retailer location using one or more computer-vision techniques. To do so, the online system 140 may apply the computer-vision technique(s) to the image or video data, access a layout of the retailer location, compare the physical elements included in the image or video data to the layout, and detect 310 the location and/or the orientation associated with the customer within the retailer location based on the comparison. FIG. 4 illustrates an example of detecting 310 a location associated with a user of an online system 140 within a retailer location, in accordance with one or more embodiments. As shown in the example of FIG. 4, suppose that the online system 140 received 305 image or video data captured by a camera of the customer client device 100 as the customer travels along a route 400 through the retailer location, in which the image or video data includes various physical elements (e.g., items, aisles, display tables, faces, hands, shopping baskets, etc.) within the retailer location. In this example, the online system 140 may apply image processing, pattern recognition, and object detection techniques to the image or video data to detect and identify the physical elements, such as a display table 405 in a gourmet foods department and a service counter 410 in a bakery department. Continuing with this example, the online system 140 may then access a layout of the retailer location and compare the physical elements included in the image or video data to those of various locations within the layout. In the above example, the online system 140 may then detect 310 the location and/or the orientation associated with the customer within the retailer location based on the comparison if the physical elements included in the image or video data have at least a threshold measure of similarity to those for the corresponding locations and/or orientations in the layout. In some embodiments, the location and/or the orientation associated with the customer within the retailer location detected 310 by the online system 140 may be associated with one or more times. For example, if video data used by the online system 140 to detect 310 the location and the orientation associated with the customer within the retailer location includes a timestamp associated with each video frame, the location and orientation associated with the customer may be associated with a timespan during which the video data indicates the customer is associated with the location and orientation.

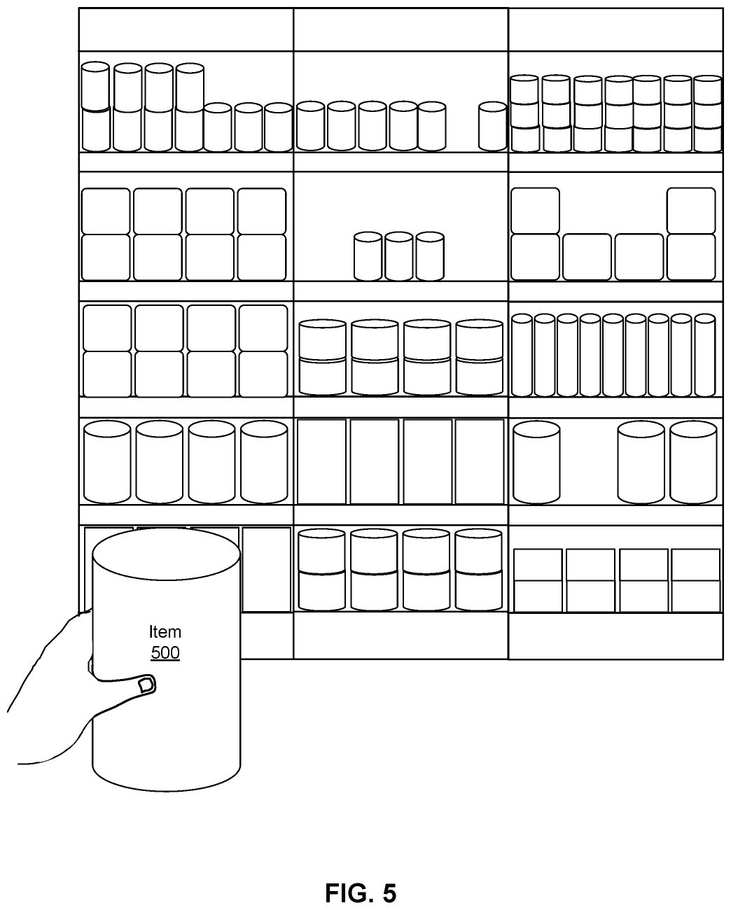

Referring again to FIG. 3, for each retailer location associated with the retailer(s) associated with the online system 140, the online system 140 also or alternatively may detect 310 (e.g., using the interaction detection module 260) an interaction by the customer with an item included among an inventory of the retailer location. The online system 140 may detect 310 the interaction by the customer with an item based at least in part on the data received 305 by the online system 140. In embodiments in which the data received 305 by the online system 140 are image or video data, the online system 140 may detect 310 the interaction by the customer with the item by applying one or more computer-vision techniques to the image or video data. FIG. 5 illustrates an example of detecting 310 an interaction by a user of an online system 140 with an item included among an inventory of a retailer location, in accordance with one or more embodiments. As shown in the example of FIG. 5, suppose that the online system 140 receives 305 image or video data captured by a camera of the customer client device 100, in which the image or video data includes various physical elements (e.g., items, aisles, display tables, faces, hands, shopping baskets, etc.) within the retailer location. In this example, the online system 140 may apply image processing, pattern recognition, and object detection techniques to the image or video data to detect and identify the physical elements. Continuing with this example, the online system 140 may then detect 310 that the customer associated with the customer client device 100 picked up an item 500 and subsequently put the item 500 back on a shelf at the retailer location. Alternatively, in the above example, the online system 140 may detect 310 that the customer placed the item 500 in a shopping basket or a shopping cart after picking it up and subsequently acquired the item 500 by purchasing it from the retailer location. In some embodiments, the interaction by the customer with the item 500 detected 310 by the online system 140 may be associated with one or more times. For example, if video data used by the online system 140 to detect 310 the interaction by the customer with an item 500 at the retailer location includes a timestamp associated with each video frame, the interaction may be associated with a timespan during which the interaction is depicted by the video data.

Referring back to FIG. 3, the online system 140 then generates 315 (e.g., using the signal generation module 270) a set of signals associated with the customer. In some embodiments, the online system 140 may generate 315 the set of signals based at least in part on a location and/or an orientation associated with the customer within a retailer location detected 310 by the online system 140. In such embodiments, the set of signals may include information describing the retailer location, one or more times at which the location and/or the orientation are associated with the customer, one or more types of items 500 associated with the location and/or the orientation associated with the customer, or any other suitable types of information. For example, if the online system 140 detects 310 that the customer is located within a frozen food aisle within a retailer location and is oriented towards certain items 500 (e.g., ice cream), the online system 140 may generate 315 the set of signals associated with the customer including information identifying the retailer location and an amount of time that the customer is in the aisle and oriented towards the items 500.

In various embodiments, the online system 140 also may generate 315 the set of signals associated with the customer based on an interaction by the customer with an item 500 included among the inventory of a retailer location detected 310 by the online system 140. In such embodiments, the set of signals may include information associated with the item 500 (e.g., brand, item category/categories, price, sale, discount, ingredient(s), size(s), color(s), weight, SKU, serial number, quality, material(s), manufacturing location, etc.). The set of signals also may include information describing the retailer location, a type of the interaction, such as picking up the item 500, purchasing the item 500, putting the item 500 back (e.g., on a shelf, a table, or other display area), putting the item 500 in a shopping basket or a shopping cart, one or more times associated with the interaction by the customer with the item 500, or any other suitable types of information. For example, if the online system 140 detects 310 that the customer picked up an item 500, put it back, and left a retailer location without purchasing it, the set of signals may include information identifying the retailer location, information describing the item 500 (e.g., brand, price, item category/categories, etc.), a time at which the customer picked it up, and a time at which the customer put it back.

The online system 140 then performs 320, based at least in part on the set of signals, one or more of the following: determining (e.g., using the preference determination module 280) a set of preferences associated with the customer, training (e.g., using the machine learning training module 230) a machine learning model to predict a metric associated with the customer, and sending (e.g., using the content presentation module 210) content for display to a customer client device 100 associated with the customer.

In embodiments in which the online system 140 determines a set of preferences associated with the customer, the set of preferences may include shopping preferences, dietary preferences (e.g., vegetarian, gluten-free, etc.), or any other suitable types of preferences. For example, the customer may have a preference for certain brands of items 500, certain categories of items 500 (e.g., cheeses or Italian food), certain ingredients (e.g., whole grains, gluten-free, etc.), and certain qualities of items 500 (e.g., organic green bananas). As described above, the online system 140 may determine the set of preferences associated with the customer based on the set of signals associated with the customer generated 315 by the online system 140. For example, if the set of signals generated 315 by the online system 140 indicates that while at a retailer location, the customer spent ten minutes in a gourmet foods department, the online system 140 may determine 140 that the customer has a preference for gourmet foods from that retailer location. As an additional example, if the set of signals indicates that the customer never spends any time in an alcohol aisle of a first retailer location, but spends several minutes in an alcohol aisle of a second retailer location, the online system 140 may determine that the customer is not interested in alcohol from the first retailer location, but is interested in alcohol from the second retailer location. As yet another example, if the set of signals generated 315 by the online system 140 indicates that after picking up items 500 from a meat department of a retailer location, the customer put the items 500 back if they were not on sale, but purchased the items 500 if they were on sale, the online system 140 may determine that the customer has a preference for items 500 at the retailer location in the meat department that are on sale. Once the online system 140 has determined the set of preferences associated with the customer, the set of preferences may be collected by the online system 140 (e.g., using the data collection module 200) and included among the customer data (e.g., stored in the data store 240).

In embodiments in which the online system 140 trains a machine learning model to predict a metric associated with the customer, the metric may be a likelihood of conversion for an item 500 by the customer, a maximum amount the customer is likely to spend on a type of item 500, an affinity of the customer for a brand, a relevance of a content item to the customer, the customer's click-through rate for a content item, or any other suitable type of metric. For example, the machine learning model may be trained to predict a likelihood that the customer will place an order including an item 500 with the online system 140 or purchase the item 500 from a retailer location. The online system 140 may train the machine learning model via supervised learning based at least in part on attributes of items 500 included among the item data (e.g., stored in the data store 240) and attributes of customers, which may be included among the customer data (e.g., stored in the data store 240) and/or the set of signals associated with the customer generated 315 by the online system 140. In some embodiments, the machine learning model uses item embeddings describing items 500 and customer embeddings describing customers to predict a metric associated with the customer. These item embeddings and customer embeddings may be generated by separate machine learning models and may be stored (e.g., in the data store 240).

To illustrate an example of how a machine learning model may be trained to predict a metric associated with the customer, suppose that the online system 140 receives a set of training examples. In this example, the set of training examples may include attributes of items 500 (e.g., sizes, colors, weights, SKUs, serial numbers, prices, item categories, brands, sales, discounts, qualities, ingredients, materials, manufacturing locations, etc. associated with the items 500). In this example, the set of training examples also may include attributes of customers, such as their shopping preferences, favorite items 500, favorite retailers, dietary preferences, demographic information, etc. Continuing with this example, the attributes of the customers further may include information describing content presented to the customers (e.g., information included in the content, a type of customer client device 100 used to present the content, a time at which the content was presented, etc.) and information describing the customers' interactions with the content (e.g., clicking on it, claiming an offer included in it, etc.). In the above example, the attributes of the customers also may include information describing the customers' interactions with items 500 in the online system 140 or at retailer locations, such as information describing types of the interactions (e.g., browsing items 500, picking up items 500, putting items 500 back, clicking on items 500, etc.), times of the interactions, and information identifying the items 500. In this example, the online system 140 also may receive labels which represent expected outputs of the machine learning model (e.g., whether a customer performed an action associated with an item 500 corresponding to a conversion by ordering/purchasing it). Continuing with this example, the online system 140 may then train the machine learning model based on the attributes of the items 500 and customers, as well as the labels by comparing its output from input data of each training example to the label for the training example.

In embodiments in which the online system 140 sends content for display to a customer client device 100 associated with the customer, the content may be sent in the form of a notification (e.g., a push notification), a banner, a recommendation, a content item in a feed of content items, or in any other suitable form. For example, based on the set of signals indicating that the customer picked up an item 500 at a retailer location, put it in a shopping basket, then put it back on a shelf, and left the retailer location without purchasing it, the online system 140 may select an offer, a coupon, a discount, or an advertisement for the item 500 for presentation to the customer. As an additional example, based on the set of signals indicating that the customer picked up an item 500 at a retailer location and put it back on a shelf, the online system 140 may select content for presentation to the customer that describes how the item 500 may be used (e.g., a recipe that includes the item 500 as an ingredient, a social networking post that demonstrates how the item 500 may be used, etc.). In the above examples, the online system 140 may overlay the content onto the item 500 at the retailer location if the customer client device 100 is an augmented reality device. Alternatively, in the above examples, the content may be presented via a client application operating on the customer client device 100 while the customer is at the retailer location or after the customer has left the retailer location. In some embodiments, the content may be sent to the same customer client device 100 from which the data was received 305, while in other embodiments, the content may be sent to a different customer client device 100 associated with the customer.

In some embodiments, the online system 140 may send the content for display to the customer client device 100 in association with additional types of information. Examples of such types of information include: instructions for navigating to an item 500 associated with the content, a time limit associated with the content (e.g., to claim an offer included in the content), or any other suitable types of information. For example, the online system 140 may access a layout of a retailer location (e.g., from the data store 240) and determine a navigation path from a location associated with the customer within the retailer location detected 310 by the online system 140 to an area within the retailer location at which an item 500 associated with the content selected for presentation to the customer may be collected based on the layout. Continuing with this example, the online system 140 may then send the content to the customer client device 100 in association with the navigation path.

In embodiments in which the online system 140 sends content for display to the customer client device 100 associated with the customer, the online system 140 may score items 500 based on a search query received from the customer client device 100, item data for the items 500, customer data for the customer, and/or the set of signals associated with the customer. The online system 140 may then send the content for display to the customer client device 100 based on the scores. For example, the online system 140 may score items 500 for presentation to the customer based on a relatedness of the items 500 to a search query received from the customer client device 100 and on customer data and signals associated with the customer indicating affinities of the customer for the items 500. As an additional example, based on a relatedness of items 500 to a search query received from the customer client device 100 and likelihoods that the customer will order the items 500, the online system 140 may score items 500 for presentation to the customer. In this example, the likelihoods may be predicted by a machine learning model (e.g., the item selection model), which may be trained based on item data for the items 500, customer data for the customer, and the set of signals associated with the customer generated 315 by the online system 140.

In embodiments in which the online system 140 sends content for display to the customer client device 100 associated with the customer, the online system 140 also may score items 500 based on information received from one or more picker client devices 110 and send the content for display to the customer client device 100 based on the scores. The information received from the picker client device(s) 110 may describe an availability of an item 500, a popularity of an item 500, or any other suitable types of information. For example, if information received from picker client devices 110 indicate that an item 500 is being collected from a retailer location at a rate that is at least a threshold rate, the online system 140 may weigh the score for the item 500 more heavily than the scores for items 500 that are not being collected from the retailer location at rates that are at least the threshold rate. As an additional example, based on information received from a picker client device 110 indicating that fewer than a threshold number of an item 500 are available at a retailer location, such that the item 500 is discounted for quick clearance, the online system 140 may weigh the score for the item 500 more heavily than the scores for items 500 that are not discounted for quick clearance.

In embodiments in which the online system 140 sends content for display to the customer client device 100 associated with the customer, the online system 140 subsequently may determine whether the customer performed an action associated with the content (e.g., acquiring an item 500 associated with the content). In such embodiments, the action associated with the content may be performed by the customer while the customer is at a retailer location (e.g., by purchasing an item 500 associated with the content from the retailer location) and information describing the action may be detected 310 by the online system 140 (e.g., using the interaction detection module 260). Alternatively, the action associated with the content may be performed by the customer while the customer is at another location (e.g., by placing an order including an item 500 associated with the content with the online system 140) and information describing the action may be received by the online system 140 (e.g., via the order management module 220). Furthermore, in such embodiments, the online system 140 may then train (e.g., using the machine learning training module 230) a machine learning model to predict a metric associated with the customer based at least in part on whether the customer performed the action associated with the content, as described above.

### Additional Considerations

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated with the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “of” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

1. A method, performed at a computer system comprising a processor and a computer-readable medium, comprising:
for each retailer location of a plurality of retailers associated with an online system:
receiving video data captured within a corresponding retailer location by a camera of a device associated with a user of the online system,
detecting an interaction by the user with an item included among an inventory of the corresponding retailer location based on the video data, and
detecting a timestamp at which the interaction occurred based on the video data;
generating a video-based set of signals associated with the user based at least in part on the detecting, wherein the video-based set of signals describes the timestamps at which each detected interaction occurred;
storing the video-based set of signals in a user database of the online system in association with the user;
receiving a request for content from a client device associated with the user of the online system, wherein the request comprises a search query;
generating search results for the search query based on the video-based set of signals by:
accessing a set of candidate items to present to the user from an item database of the online system;
generating a score for each of the set of candidate items by applying a content scoring model to item data describing the candidate item, search query, and the stored video-based set of signals associated with the user, wherein the content scoring model is a neural network that is trained to generate scores for candidate items based on item data describing those items, search queries from users, and signals describing in-location user behavior generated based on video data, wherein the signals describe timestamps at which user interactions occurred; and
generating the search results by selecting a subset of the set of candidate items based on the generated scores; and
transmitting a user interface to the client device for display to the user, wherein the user interface comprises generated search results.

2. (canceled)

3. The method of claim 1, wherein the set of signals associated with the user comprises one or more of: a brand associated with the item, an item category associated with the item, a price associated with the item, a sale associated with the item, a discount associated with the item, an ingredient associated with the item, a size associated with the item, a color associated with the item, a weight associated with the item, a stock keeping unit associated with the item, a serial number associated with the item, a quality associated with the item, a material associated with the item, a manufacturing location associated with the item, information describing the retailer location, a type of the interaction by the user with the item, or a time at which the interaction by the user with the item is detected.

4. The method of claim 1, wherein the interaction by the user with the item comprises one or more of: picking up the item, putting the item in a display area, placing the item in a shopping basket, placing the item in a shopping cart, or acquiring the item.

5. (canceled)

6. The method of claim 1, further comprising:
responsive to transmitting the user interface to the client device, determining whether the user acquired the item; and
training the content scoring model based at least in part on whether the user acquired the item.

7-8. (canceled)

9. The method of claim 1, wherein the camera is included on a device comprising one or more of: a shopping cart system, an augmented reality system, or a mobile computing device.

10. The method of claim 1, wherein detecting the interaction by the user with the item included among the inventory of the corresponding retailer location comprises:
applying one or more computer-vision techniques to the video data; and
detecting the interaction by the user with the item included among the inventory of the corresponding retailer location based at least in part on the applying the one or more computer-vision techniques to the video data.

11. A computer program product comprising a non-transitory computer-readable storage medium having instructions encoded thereon that, when executed by a processor, cause the processor to perform steps comprising:
for each retailer location of a plurality of retailers associated with an online system:
receiving video data captured within a corresponding retailer location by a camera of a device associated with a user of the online system,
detecting an interaction by the user with an item included among an inventory of the corresponding retailer location based on the video data, and
detecting a timestamp at which the interaction occurred based on the video data;
generating a video-based set of signals associated with the user based at least in part on the detecting, wherein the video-based set of signals describes the timestamps at which each detected interaction occurred;
storing the video-based set of signals in a user database of the online system in association with the user;
receiving a request for content from a client device associated with the user of the online system, wherein the request comprises a search query;
generating search results for the search query based on the video-based set of signals by:
accessing a set of candidate items to present to the user from an item database of the online system;
generating a score for each of the set of candidate items by applying a content scoring model to item data describing the candidate item, search query, and the stored video-based set of signals associated with the user, wherein the content scoring model is a neural network that is trained to generate scores for candidate items based on item data describing those items, search queries from users, and signals describing in-location user behavior generated based on video data, wherein the signals describe timestamps at which user interactions occurred; and
generating the search results by selecting a subset of the set of candidate items based on the generated scores; and
transmitting a user interface to the client device for display to the user, wherein the user interface comprises generated search results.

12. (canceled)

13. The computer program product of claim 11, wherein the set of signals associated with the user comprises one or more of: a brand associated with the item, an item category associated with the item, a price associated with the item, a sale associated with the item, a discount associated with the item, an ingredient associated with the item, a size associated with the item, a color associated with the item, a weight associated with the item, a stock keeping unit associated with the item, a serial number associated with the item, a quality associated with the item, a material associated with the item, a manufacturing location associated with the item, information describing the retailer location, a type of the interaction by the user with the item, or a time at which the interaction by the user with the item is detected.

14. The computer program product of claim 11, wherein the interaction by the user with the item comprises one or more of: picking up the item, putting the item in a display area, placing the item in a shopping basket, placing the item in a shopping cart, or acquiring the item.

15. (canceled)

16. The computer program product of claim 11, wherein the computer-readable storage medium further has instructions encoded thereon that, when executed by the processor, cause the processor to perform steps comprising:
responsive to transmitting the user interface to the client device, determining whether the user acquired the item; and
training the content scoring model based at least in part on whether the user acquired the item.

17-18. (canceled)

19. The computer program product of claim 11, wherein the camera is included on a device comprising one or more of: a shopping cart system, an augmented reality system, or a mobile computing device.

20. A computer system comprising:
a processor; and
a non-transitory computer-readable storage medium storing instructions that, when executed by the processor, perform actions comprising:
for each retailer location of a plurality of retailers associated with an online system:
receiving video data captured within a corresponding retailer location by a camera of a device associated with a user of the online system,
detecting an interaction by the user with an item included among an inventory of the corresponding retailer location based on the video data, and
detecting a timestamp at which the interaction occurred based on the video data;
generating a video-based set of signals associated with the user based at least in part on the detecting, wherein the video-based set of signals describes the timestamps at which each detected interaction occurred;
storing the video-based set of signals in a user database of the online system in association with the user;
receiving a request for content from a client device associated with the user of the online system, wherein the request comprises a search query;
generating search results for the search query based on the video-based set of signals by:
accessing a set of candidate items to present to the user from an item database of the online system;
generating a score for each of the set of candidate items by applying a content scoring model to item data describing the candidate item, search query, and the stored video-based set of signals associated with the user, wherein the content scoring model is a neural network that is trained to generate scores for candidate items based on item data describing those items, search queries from users, and signals describing in-location user behavior generated based on video data, wherein the signals describe timestamps at which user interactions occurred; and
generating the search results by selecting a subset of the set of candidate
items based on the generated scores; and
transmitting a user interface to the client device for display to the user, wherein the user interface comprises generated search results.
